(19) United States
(12) Patent Application Publication
(10) Pub. No.: US 2024/0380849 A1
(43) Pub. Date: Nov. 14, 2024

(54) SUPPORT APPARATUS AND NON-TRANSITORY COMPUTER-READABLE STORAGE MEDIUM

(71) Applicant: CANON KABUSHIKI KAISHA, Tokyo (JP)

(72) Inventor: Shogo Higashi, Kanagawa (JP)

(21) Appl. No.: 18/652,858

(22) Filed: May 2, 2024

(30) Foreign Application Priority Data
May 9, 2023 (JP) 2023-077386

(51) Int. Cl. H04N 1/00; G06K 15/00; G06K 15/02

(52) U.S. Cl. CPC H04N 1/00074; G06K 15/027; G06K 15/408; H04N 1/00015; H04N 1/00029; H04N 1/00045; H04N 1/0005; H04N 1/00055; H04N 1/00082; H04N 1/00909

(57) ABSTRACT

A support apparatus that supports maintenance of a printing apparatus, the support apparatus comprising at least one processor and at least a memory coupled to the at least one processor and having instructions stored thereon that, when executed by the at least one processor, causes the processor to act as a printing execution unit configured to cause the printing apparatus to execute printing of a test pattern, a specifying unit configured to specify, based on the test pattern being printed, content of maintenance required for the printing apparatus, and a notification unit configured to notify based on the content being specified.

### BACKGROUND OF THE INVENTION

### Field of the Invention

The present invention relates to a support apparatus.

### Description of the Related Art

In some printing apparatuses, when the quality of a printed image does not satisfy a standard, the image is diagnosed to perform self-repair of the apparatus (see Japanese Patent Laid-Open No. 2022-137718).

In a configuration disclosed in Japanese Patent Laid-Open No. 2022-137718, when it is difficult to perform self-repair of the apparatus, it is necessary to receive a maintenance service from an apparatus manufacturer or the like. Therefore, an operator may be required to specify the content of maintenance or a maintenance factor. This may cause a load on the operator, and thus there is room for improvement in terms of usability.

The present invention has been made in light of the above-described problem recognized by the inventor, and an object of the present invention is to provide a technique advantageous in improving usability of a printing apparatus.

### SUMMARY OF THE INVENTION

One of the aspects of the present invention provides a support apparatus that supports maintenance of a printing apparatus, the support apparatus comprising at least one processor and at least a memory coupled to the at least one processor and having instructions stored thereon that, when executed by the at least one processor, causes the processor to act as a printing execution unit configured to cause the printing apparatus to execute printing of a test pattern, a specifying unit configured to specify, based on the test pattern being printed, content of maintenance required for the printing apparatus, and a notification unit configured to notify based on the content being specified.

Further features of the present invention will become apparent from the following description of exemplary embodiments (with reference to the attached drawings).

### BRIEF DESCRIPTION OF THE DRAWINGS

FIG. 1 is a diagram illustrating a configuration example of a support system according to an embodiment.

FIG. 2 is a block diagram illustrating a configuration example of a web system and the like.

FIG. 3 is a block diagram illustrating an example of configuration for realizing functions of an image forming apparatus.

FIG. 4 is a block diagram illustrating a configuration example of the web system and a printing company system.

FIG. 5A and FIG. 5B are flowcharts illustrating an example of the content of processing for performing image diagnosis.

FIG. 6A is a diagram illustrating an example of a UI screen displaying a list of items required for executing an inspection.

FIG. 6B is a diagram illustrating an example of a UI screen for registering a correct image.

FIG. 6C is a diagram illustrating an example of a UI screen indicating that the correct image is being read.

FIG. 6D is a diagram illustrating an example of a UI screen prompting registration of the correct image.

FIG. 6E is a diagram illustrating an example of a UI screen for setting inspection conditions.

FIG. 6F is diagram illustrating an example of a UI screen indicating that the inspection is being executed.

FIG. 6G is a diagram illustrating an example of a UI screen for checking results of the inspections performed in the past.

FIG. 6H is a diagram illustrating an example of a UI screen indicating that the image diagnosis is being executed.

FIG. 6I is a diagram illustrating an example of a UI screen for checking diagnosis results in the past.

FIG. 7A is a diagram illustrating an example of a search screen for searching for a product on which maintenance is to be performed.

FIG. 7B is a diagram illustrating an example of a product information screen.

FIG. 7C is a diagram illustrating an example of a data collection screen.

FIG. 7D is a diagram illustrating an example of a data analysis screen.

FIG. 8 is a diagram illustrating an example of diagnosis data.

FIG. 9 is a diagram illustrating an example of an SMD database.

FIG. 10 is a flowchart illustrating another example of the content of the processing for executing the image diagnosis.

FIG. 11 is a diagram illustrating an example of an image diagnosis execution timing setting screen.

FIG. 12 is a diagram illustrating an example of a setting screen for adjustment items.

FIG. 13 is a diagram illustrating an example of a database listing the adjustment items corresponding to each inspection type.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

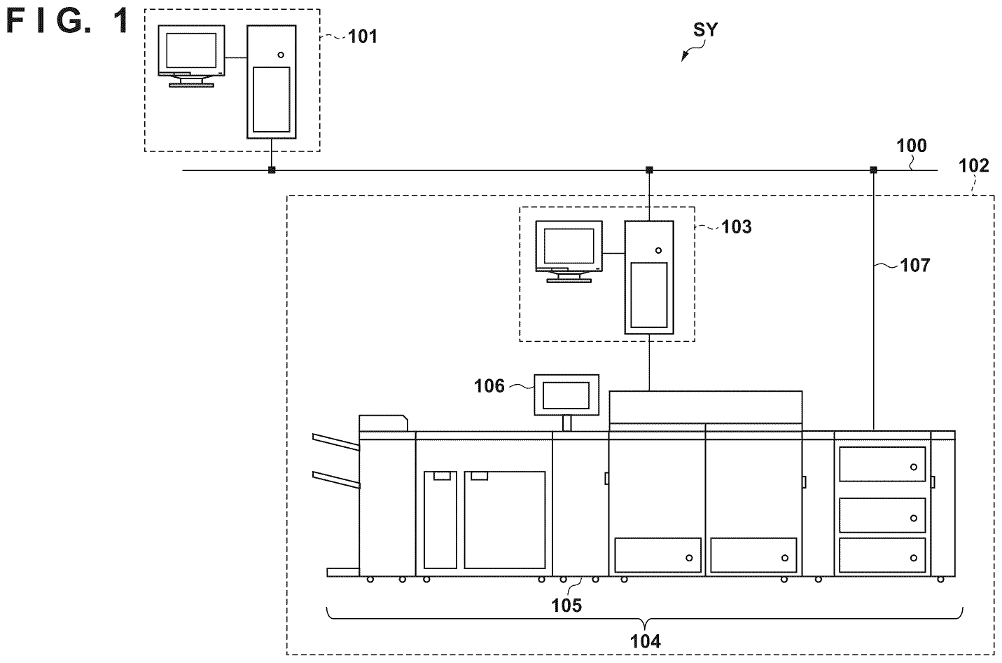

FIG. 1 is a diagram illustrating a configuration example of a support system SY according to a first embodiment. Although details will be described later, the support system SY is configured to support maintenance (typically inspection, repair, or the like of the apparatus, but can be interpreted in a broad sense here) of an image forming apparatus 104. The support system SY includes a web system 101 and a printing company system 102, which are communicably connected to each other via a network 100.

Although the web system 101 may belong to an owner of the support system SY, the web system 101 may belong to a third party or may be configured by, for example, a cloud server.

The web system 101 is a system configured to detect a maintenance request and check a maintenance history in the printing company system 102. Functions of the web system 101 may be provided in a digital front end (DFE) 103, which will be described later. For example, monitoring of the printing company system 102 can be realized by the DFE 103 without using the web system 101.

The printing company system 102 includes the DFE 103 and the image forming apparatus 104. The image forming apparatus 104 is configured to be able to execute image formation or printing on a sheet (for example, a sheet-like recording medium such as a paper material). The concept of an image may typically include characters, graphics, photographs, and the like. The image forming apparatus 104 may also be referred to as a printing apparatus 104.

The DFE 103 mainly perform data processing or signal processing on job data input from the web system 101 or the like to the image forming apparatus 104. Examples of the processing include correction, editing, high-speed RIP processing, and the like of job data, and storing, management, and the like of job data obtained thereby. The job data may also be referred to as print job data.

Functions of the DFE 103 may be provided in the web system 101. For example, series of operations from reception of the job data to data processing may be consistently performed by the web system 101. In this case, from the viewpoint of the image forming apparatus 104, it can be said that the web system 101 provides the functions of the DFE 103 via the network 100, in place of the DFE 103.

For example, an input/output apparatus such as a liquid crystal display or a keyboard may be additionally installed in the DFE 103. The same also applies to the web system 101. Regardless of an installation mode of such an additional apparatus, the image forming apparatus 104 may be directly connected to the network 100 via a network cable 107.

The image forming apparatus 104 includes an inspection apparatus 105 configured to inspect whether or not an image printed on a sheet satisfies a standard (typically, whether or not the quality of the image satisfies the standard). The image forming apparatus 104 further includes an inspection personal computer (PC) 106, and thereby, the image forming apparatus 104 can realize a setting function for setting the content of an inspection by the inspection apparatus 105, a checking function for checking an inspection result, and the like.

In addition, the image forming apparatus 104 may further include a known printing mechanism such as a sheet feeding unit configured to feed a sheet, a conveyance unit configured to convey the sheet, a printing unit configured to execute printing on the sheet, and a paper discharge unit configured to discharge the printed sheet (hereinafter also referred to as a “printed material”). The image forming apparatus 104 may further have a post-processing function such as a function of binding or aligning a plurality of the printed materials, or a function of changing a discharge destination of the plurality of sheets to another discharge tray.

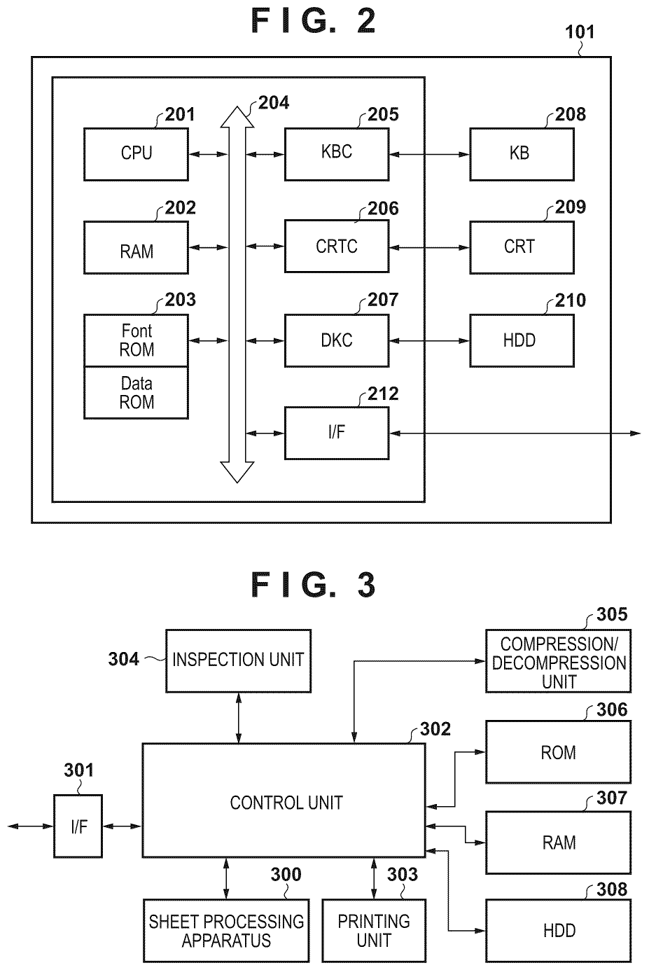

FIG. 2 is a block diagram illustrating a configuration example of the web system 101, the DFE 103, or the inspection PC 106. For example, the web system 101 includes a central processing unit (CPU) 201, a random access memory (RAM) 202 and a read only memory (ROM) 203. The web system 101 further includes a bus 204, a keyboard controller (KBC) 205, a cathode ray tube controller (CRTC) 206, and a disk controller (DKC) 207. The web system 101 further includes a keyboard (KB) 208, a cathode ray tube (CRT) 209, a hard disk drive (HDD) 210, and an external interface (I/F) 212.

The CPU 201 executes a program stored in the ROM 203 or a program such as an operating system (OS) application program read from the HDD 210 to the RAM 202. The RAM 202 functions as a main memory, a work area, or the like of the CPU 201. The ROM 203 includes a font ROM, a data ROM, and the like, and manages and stores information, such as programs and data, for each function.

The KBC 205 controls an operation input from the KB 208 and also controls an operation input from a pointing device (not illustrated). The CRTC 206 controls a display output to the CRT 209. The HDD 210 stores a boot program, an application program, font data, and the like, and the DKC 207 controls access to the HDD 210. The I/F 212 controls communication with an external apparatus connected to the network 100.

The bus 204 connects the CPU 201 to the RAM 202, the ROM 203, various controllers 205 to 207, and the I/F 212, and enables exchange or transfer of data, information, or signals between the elements.

The configuration of the web system 101, the DFE 103, or the inspection PC 106 is not limited to the example illustrated in FIG. 2, and may be partially changed without departing from the scope of the invention. For example, when a mobile terminal is used, a touch panel controller may be used in place of the KBC 205. Further, in place of the HDD 210, a nonvolatile memory such as a solid state drive (SSD) may be used, or other known mass storage apparatuses may be used. Furthermore, in place of or in conjunction with the I/F 212, a wired LAN and/or a wireless LAN may be used.

The above-described abbreviations such as I/F may be used in other descriptions and drawings to be described later.

FIG. 3 is a block diagram illustrating an example of a configuration for realizing the functions of the image forming apparatus 104.

The image forming apparatus 104 includes a sheet processing apparatus 300, an I/F 301, a control unit 302, a printing unit (image forming unit) 303, an inspection unit 304, a compression/decompression unit 305, a ROM 306, a RAM 307, and an HDD 308. The control unit 302 has a function as a CPU, and performs drive control of each element of the image forming apparatus 104.

The ROM 306 is a read-only memory, and stores programs and data, such as a boot sequence and font information, necessary for realizing the functions. For example, the ROM 306 stores a program executable by the control unit 302. As an example, the ROM 306 stores a printing control program used for execution of the printing, and the printing control program enables drive control of the printing unit 303. Further, the ROM 306 stores a program or the like for interpreting page description language data (hereinafter referred to as PDL data) received by the control unit 302 via the I/F 301 and developing the PDL data into raster image data (for example, bit map image data). Furthermore, the ROM 306 stores a program or the like for interpreting and processing a print job received by the control unit 302 via the I/F 301. These programs are processed by software.

The RAM 307 is a readable and writable memory, and stores the above-described programs, setting information necessary for execution of the programs, and the like, in addition to image data received via the I/F 301.

The HDD 308 stores, for example, job data received from an external apparatus via the I/F 301. The HDD 308 can further store management information that can be managed by the image forming apparatus 104. Further, the compression/decompression unit 305 compresses or decompresses the image data stored in the RAM 307 or the HDD 308 using a compression method such as JBIG or JPEG, and the HDD 308 can further store the image data compressed by the compression/decompression unit 305.

The control unit 302 stores, in the HDD 308, job data received via the I/F 301, reads job data from the HDD 308, outputs the job data to the printing unit 303, and causes the printing unit 303 to execute printing. In executing the printing, the sheet processing apparatus 300 sequentially conveys sheets toward the printing unit 303 and outputs the sheets being printed to the outside. Further, the control unit 302 can also transmit the job data read from the HDD 308 to an external apparatus via the I/F 301.

With such a configuration, the printing unit 303 executes the printing corresponding to the job data, based on the program in the ROM 306. A printing mode by the image forming apparatus 104 may be color printing or monochrome printing.

The inspection unit 304 inspects whether or not the quality of the image of the printed material generated by the printing unit 303 satisfies a standard (for example, presence or absence of stain, blur, or the like), notifies the inspection result, and outputs a signal for stopping the printing operation as necessary. In addition, the inspection unit 304 has a diagnosis function of specifying and notifying the content of maintenance required for the image forming apparatus 104 by printing a diagnosis chart (or a test pattern) and reading it.

That is, the inspection unit 304 has an inspection function of inspecting the quality of the printed material, and a diagnosis function of performing diagnosis to determine whether or not maintenance of the image forming apparatus 104 is necessary, both of which will be described in detail later. Although a considerable number of sheets are used to realize any of these functions, in order to simplify the description, it is here assumed that a sufficient number of unprinted sheets are installed in the image forming apparatus 104. Further, the inspection function may also be referred to as an image inspection function, a printed material inspection function, or the like, and the diagnosis function may also be referred to as an apparatus diagnosis function, a maintenance necessity diagnosis function, or the like. Furthermore, the inspection function and the diagnosis function may be simply referred to as a first function and a second function to be distinguished from each other.

Although the inspection unit 304 corresponds to the inspection apparatus 105 and the inspection PC 106, a part thereof may be included in another unit. Alternatively, the inspection unit 304 may include a part of another unit.

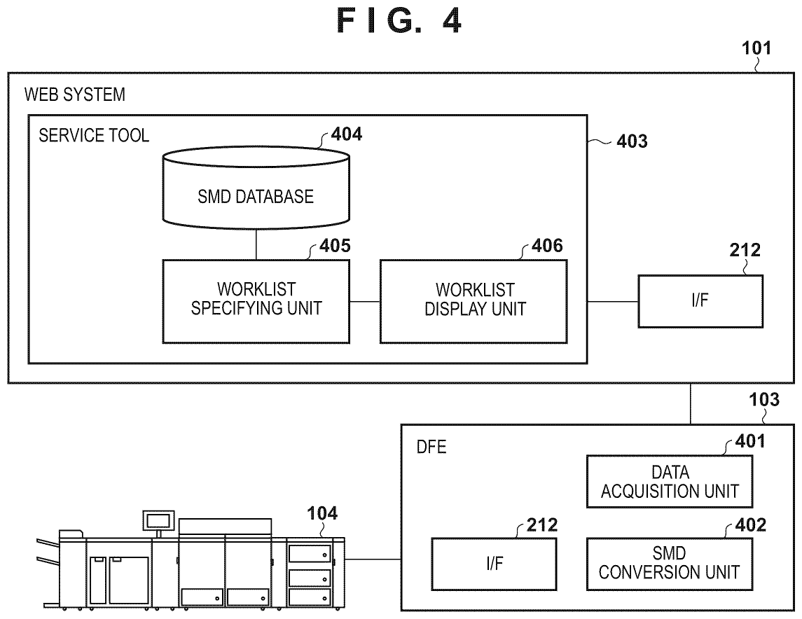

FIG. 4 is a block diagram illustrating a configuration example of the web system 101 and the printing company system 102 in the support system SY.

In the printing company system 102, the DFE 103 includes a data acquisition unit 401 and a service master data (SMD) conversion unit 402. The data acquisition unit 401 acquires, from the image forming apparatus 104, data or information indicating the diagnosis result based on the diagnosis function of the image forming apparatus 104, the state of the image forming apparatus 104, or the like, and stores the acquired data or information. Based on the data stored in the data acquisition unit 401, the SMD conversion unit 402 generates a code for specifying the content in an SMD database 404, which will be described later.

The web system 101 includes a service tool 403. The service tool 403 is used for recording the content of maintenance to be performed by an operator, and includes the SMD database 404, a worklist specifying unit 405, and a worklist display unit 406. The SMD database 404 holds information required for the maintenance of the image forming apparatus 104 and the DFE 103. The worklist specifying unit 405 specifies the content of maintenance based on the code converted by the SMD conversion unit 402 and subsequently received from the DFE 103, and specifies the content as recommended work to be performed by the operator. The worklist display unit 406 displays the recommended work specified by the worklist specifying unit 405.

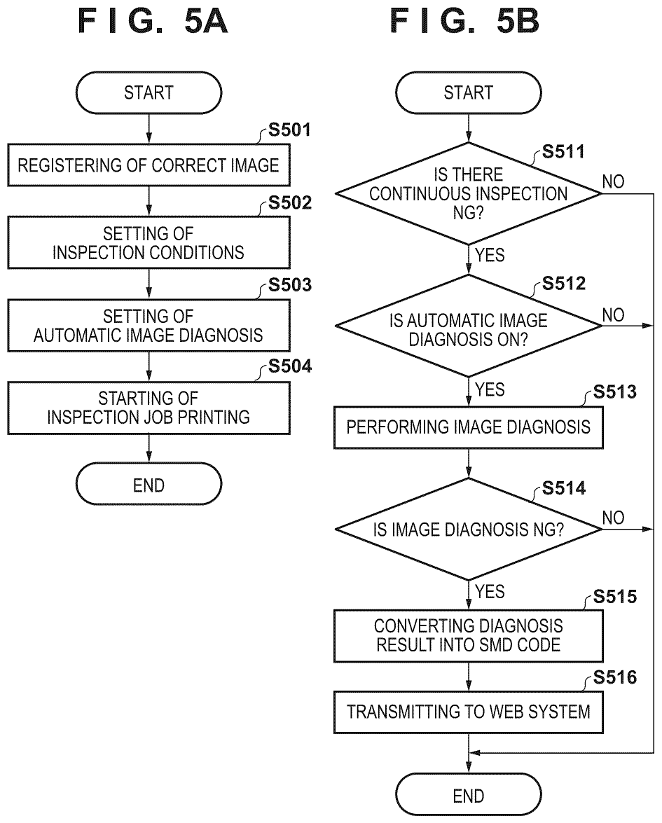

FIG. 5A and FIG. 5B are flowcharts illustrating the content of processing performed when the image forming apparatus 104 executes the diagnosis function to perform image diagnosis.

FIG. 5A illustrates, as the first half of the content of processing, a flowchart up to the start of the printing operation. This processing may be performed, in the inspection PC 106, by an operator of the printing company system 102 via a user interface (UI) screen, which will be described later.

At step S501 (hereinafter simply referred to as “S501”, and the same applies to other steps described later), a comparison image or a sample image, which is used for determining whether or not the printed material satisfies the standard, is registered and stored in the inspection PC 106 as a correct image (registration of a correct image).

At S502, conditions of the inspection performed by the inspection PC 106 are set, and for example, a standard for determining from what viewpoint the inspection is to be performed are set (inspection condition setting).

At S503, a setting is made as to whether or not to automatically execute the image diagnosis (automatic image diagnosis setting), and subsequently, printing based on an inspection job is started at S504.

Although details will be described later, the image diagnosis based on the diagnosis function is automatically executed in response to satisfaction of a predetermined condition, and thus, the image diagnosis may be referred to as automatic image diagnosis, or may be simply referred to as diagnosis.

FIG. 5B illustrates, as the second half of the content of processing, a flowchart after the printing operation is started. This processing may be performed by the printing company system 102.

At S511, the inspection PC 106 determines the presence or absence of continuous inspection NG indicating that printed materials not satisfying the standard are continuously output while printing is being executed. A user can set the number of printed materials that constitutes the continuous inspection NG. When it is determined that the continuous inspection NG has occurred, the processing proceeds to S512, otherwise, the flowchart ends.

At S512, the inspection PC 106 determines whether or not the setting has been made to execute the automatic image diagnosis at S503. When the setting has been made to execute the automatic image diagnosis, the processing proceeds to S513, otherwise, the flowchart ends.

At S513, the inspection PC 106 executes the image diagnosis and stores the diagnosis result.

At S514, the DFE 103 checks the diagnosis result. When the diagnosis result is NG (that is, when the image does not satisfy the standard), the processing proceeds to S515, otherwise, the flowchart ends.

At S515, the DFE 103 converts the diagnosis result into a code corresponding to the SMD database 404. At S516, the DFE 103 transmits the converted code to the web system 101, and subsequently, the flowchart ends.

In this manner, after the image diagnosis is executed by the diagnosis function in the image forming apparatus 104, the diagnosis result is converted into the corresponding code and transmitted to the web system 101.

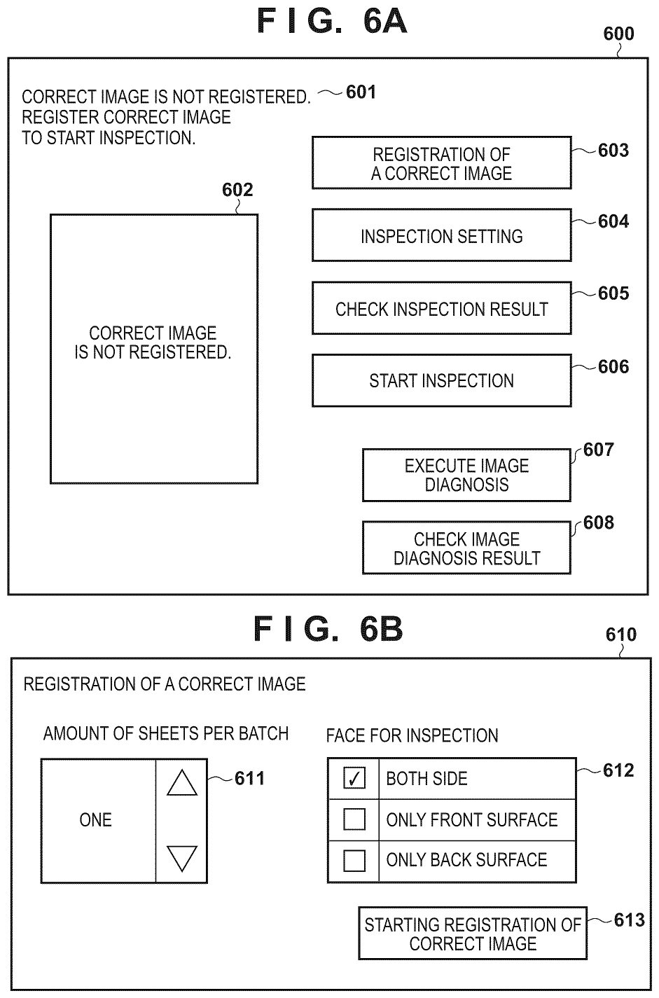

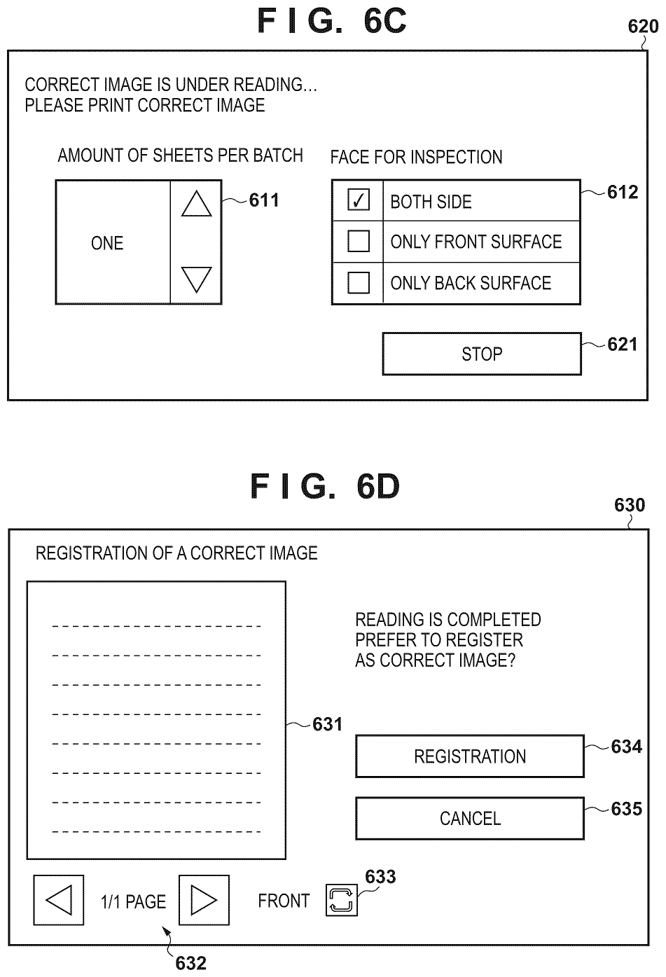

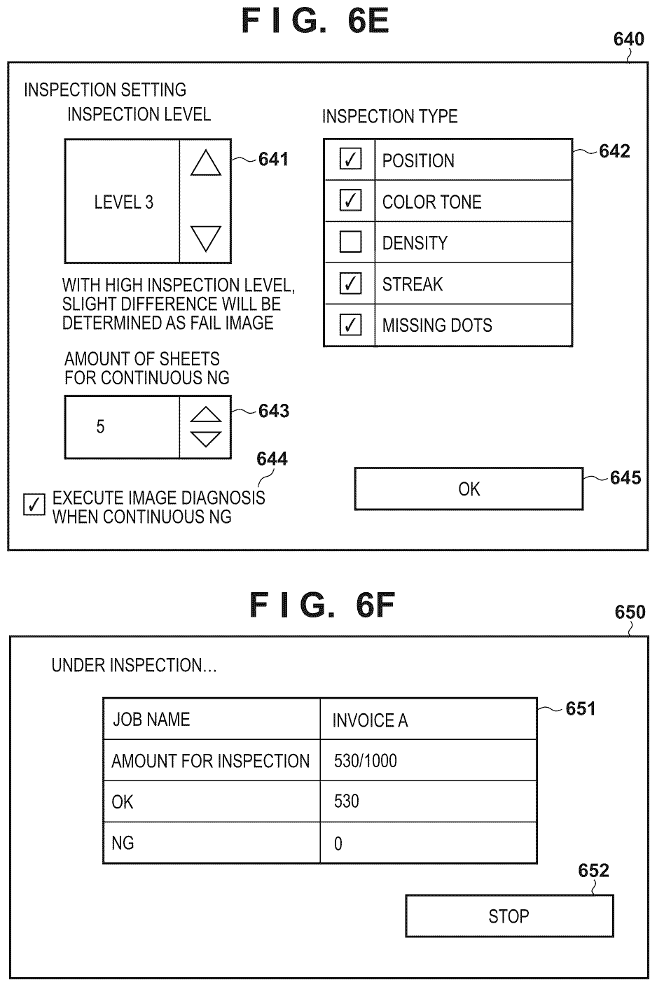

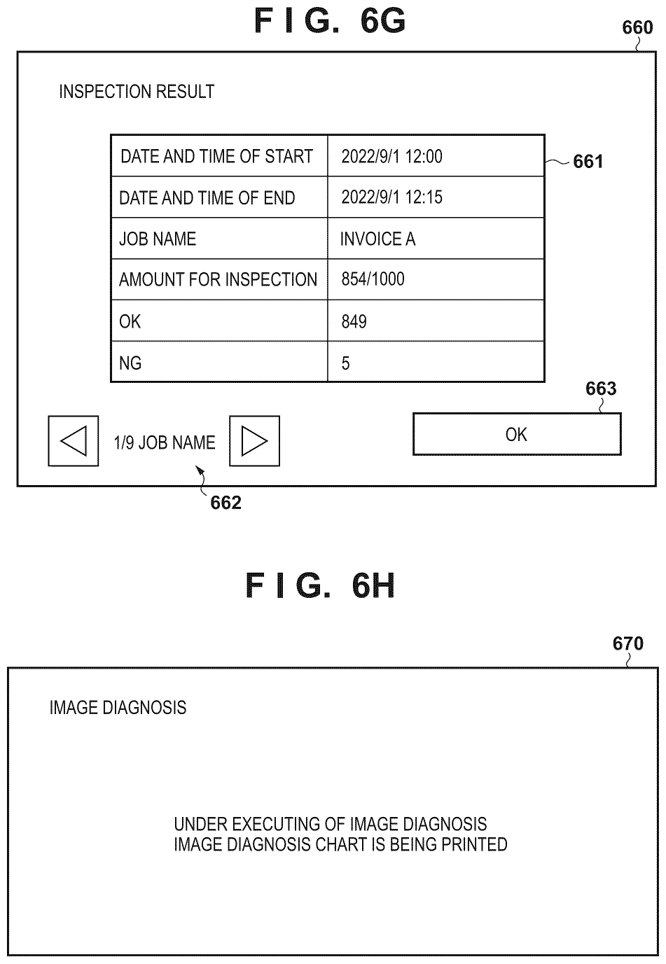

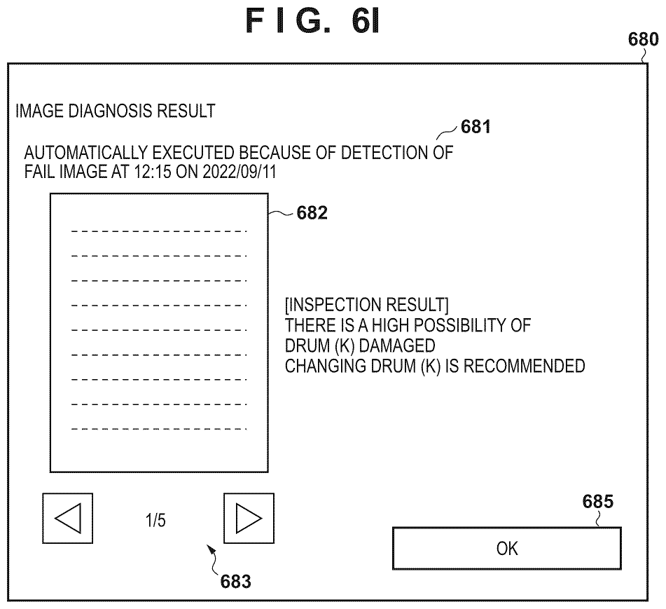

FIG. 6A to FIG. 6I are diagrams each of which illustrates an example of a UI screen used in the inspection PC 106 in the flowchart illustrated in FIG. 5A.

In FIG. 6A, an inspection menu screen 600 displaying a list of items required for executing the inspection is illustrated.

The inspection menu screen 600 includes, for example, a plurality of messages, icons, or buttons which are indicated by 601 to 608.

In the message field 601, a message indicating that the correct image is not registered, that the correct image needs to be registered in order to start inspection processing, or the like may be displayed. When the correct image is registered in advance, a message indicating that the inspection processing can be started may be displayed in the message field 601.

The registered correct image is displayed in the correct image display region 602. In this example in which the correct image is not registered, a character string “not registered” may be displayed.

A plurality of the buttons 603 to 608 may be displayed side by side to one side of the message field 601 and the correct image display region 602. The button 603 indicates “registration of a correct image”, and when pressed, a screen for registering the correct image may be displayed (see FIG. 6B to FIG. 6D). As the correct image, an image data may be used, which is acquired by the inspection apparatus 105 capturing an image selected in advance by visual observation or the like of the user as the image satisfying the standard.

The button 604 indicates “inspection setting”, and when pressed, a screen for setting the inspection conditions may be displayed (see FIG. 6E). By this operation, the user can set inspection items or the inspection accuracy in accordance with the purpose of the inspection. Examples of the inspection item include a shift of a printing position, a color tone of an image, density, streak, blur, and missing dots. The inspection accuracy is an index indicating the degree of difference between a printed image and the correct image, which is used for determining whether or not the printed image satisfies the standard. For example, when the difference is less than 1%, the standard is satisfied, and when the difference is 1% or more, the standard is not satisfied.

The button 605 indicates “check inspection result”, and when pressed, a screen for checking the inspection result may be displayed (see FIG. 6G). By this operation, the user can check the content and the result of the inspections performed in the past.

The button 606 indicates “start inspection”, and when pressed, the inspection processing may be executed. By this operation, a screen indicating that the inspection is being executed is displayed (see FIG. 6F), and at the same time, the inspection unit 304 executes the inspection on printed materials that are sequentially conveyed.

The button 607 indicates “execute image diagnosis”, and when pressed, the image diagnosis may be executed (see FIG. 6H). By this operation, the inspection unit 304 causes the control unit 302 to execute the printing of the diagnosis chart, and executes a predetermined diagnosis based on the printed diagnosis chart.

The button 608 indicates “check image diagnosis result”, and when pressed, a screen for checking the diagnosis result may be displayed (see FIG. 6I).

As illustrated in FIG. 6B, a screen 610 for registering the correct image includes a number-of-sheets setting region 611 for setting the number of sheets, an inspection surface setting region 612 for setting a surface of the sheet to be inspected, and a registration start button 613 for starting the registration of the correct image.

The user can set the number of sheets per batch of the inspection job, using a spin button provided in the number-of-sheets setting region 611. Here, when two or more sheets are designated (that is, when a plurality of the printed materials are inspected in one batch), the correct image can be registered for each sheet.

Further, the user can use the inspection surface setting region 612 to set whether the inspection is performed on both surfaces, the front surface, or the back surface of the sheet. Even when an actual printing surface is only one surface, as there is a possibility that foreign matter adheres to a non-printing surface, which is the surface on the opposite side of the printing surface, the setting may be made to perform the inspection on both surfaces.

Further, the user can read an image from a sample sheet, and can register the image as the correct image by using the registration start button 613. After having completed desired settings by using the regions 611 and 612, the user can press the registration start button 613.

As illustrated in FIG. 6C, a reading-in-progress screen 620 indicating that the correct image is being read may be displayed in response to pressing of the registration start button 613. Along with this, an image of a sample printed material being conveyed is captured by the inspection apparatus 105 and a correct image is temporarily stored together with information indicating to which surface of the printed material the image corresponds, based on the settings in the inspection surface setting region 612. Note that the reading-in-progress screen 620 may be continuously displayed until completion of the reading of the image based on the settings in the regions 611 and 612.

The reading-in-progress screen 620 includes a stop button 621, and the user can also give an instruction to stop the reading of the correct image using this button. In this case, the reading of the correct image is stopped, and at the same time, the screen returns to the inspection menu screen 600.

As illustrated in FIG. 6D, when the reading of the correct image is completed, a registration processing screen 630 prompting the registration of the correct image may be displayed from the reading-in-progress screen 620. The registration processing screen 630 includes a plurality of images, buttons, or icons which are indicated by 631 to 635.

In the confirmation display region 631, the correct image temporarily stored by the above-described reading is displayed.

When one batch includes a plurality of printed materials, the sheet switching button 632 may be used to switch the display of the correct image for each sheet. When the number of sheets set in the number-of-sheets setting region 611 of the screen 610 is 1, the sheet switching button 632 may be made inactive. A front/back switching button 633 may be used to switch the display of the correct image between the front surface and the back surface of the sheet. When the surface to be inspected set in the inspection surface setting region 612 of the screen 610 is not both surfaces, the front/back switching button 633 may be made inactive.

To one side of the elements 631 to 633, a registration completion button 634 and a cancel button 635 may be displayed side by side.

By pressing the registration completion button 634, the user can register an image displayed in the confirmation display region 631 as the correct image. At this time, based on the settings in the regions 611 and 612, the image displayed in the confirmation display region 631 is registered as the correct image in association with a corresponding sheet number (for example, the 1st sheet of 10 sheets) and the surface of the sheet (front surface or back surface). In response to the completion of the registration of the correct image, the inspection menu screen 600 may be displayed again. Note that, in this case, the registered correct image is displayed in the correct image display region 602.

Further, the user can cancel the registration of the correct image by pressing the cancel button 635, and subsequently, the inspection menu screen 600 may be displayed again. In this case, an original image (for example, the character string of “unregistered”) is displayed in the correct image display region 602.

As illustrated in FIG. 6E, a condition setting screen 640 for setting the inspection conditions includes an inspection level setting region 641, an inspection type setting region 642, a continuous inspection NG number-of-sheets setting region 643, an image diagnosis execution setting region 644, and an inspection setting completion button 645.

The user can set a detection level for determining the inspection accuracy, by using a spin button in the inspection level setting region 641. Here, it is assumed that the higher the inspection level (the larger the numerical value), the smaller the degree of tolerance between an image to be inspected and the correct image, such as for example, a slight difference between the inspected image and the correct image is determined that the image does not satisfy the standard.

Further, the user can set an inspection type or an inspection item by using the inspection type setting region 642. For example, the user can select from what viewpoint the inspection is to be performed, by using check boxes. In this example, it is assumed that five items including position, color tone, density, streak, and missing dots are prepared, and the inspection is performed for the item for which a check is input.

Further, the user can make a setting for detecting the continuous inspection NG (see S511) using the continuous inspection NG number-of-sheets setting region 643, and, in accordance with the setting, when printed materials not satisfying the standard are generated for the number of times corresponding to the set value, printing is interrupted. For example, when the set value is 1, when even one sheet of the printed material not satisfying the standard is generated, printing is interrupted. When the set value is 0, printing is not interrupted regardless of the inspection result. That is, the printing is performed until the last sheet of the printed material is printed.

Further, using the image diagnosis execution setting region 644, the user can make a setting for the image diagnosis performed when the printing is stopped due to the above-described continuous inspection NG. For example, in a case where a check is input to a check box, when the printing is stopped due to the continuous inspection NG, the image diagnosis is automatically executed.

Further, the user can complete the setting of the inspection conditions by using the inspection setting completion button 645. In response to pressing of the inspection setting completion button 645, the inspection menu screen 600 may be displayed again.

As illustrated in FIG. 6F, an inspection-in-progress screen 650 indicating that the inspection is being executed includes an inspection job information display region 651 and an inspection stop button 652. In the inspection job information display region 651, information that includes a job name to be inspected, the number of sheets to be inspected, the number of sheets determined as OK (satisfying the standard), and the number of sheets determined as NG (not satisfying the standard) may be displayed. When the inspection stop button 652 is pressed by the user, the inspection job being executed is interrupted, and the inspection menu screen 600 may be displayed again.

As illustrated in FIG. 6G, an inspection result checking screen 660 for checking the results of the inspections performed in the past includes an inspection result display region 661, an inspection result switching button 662, and an inspection result checking OK button 663. The user can check details of an arbitrary inspection result using the inspection result display region 661, and can also switch the inspection job to be displayed using the inspection result switching button 662. In FIG. 6G, nine of the inspection jobs are stored as the execution history, and among the nine inspection jobs, information of the first inspection job, that is the start date and time, the end date and time, the job name, the number of inspected sheets, the number of OK sheets, and the number of NG sheets, is displayed in the inspection result display region 661.

Further, the user can end the checking of the inspection result by pressing the inspection result checking OK button 663, and in response to this, the inspection menu screen 600 may be displayed again.

As illustrated in FIG. 6H, when execution of the image diagnosis is instructed by the button 607 (see FIG. 6A), or when a check is input to the setting region 644 (see FIG. 6E) and the continuous inspection NG is detected, a diagnosis-in-progress screen 670 indicating that the image diagnosis is being executed is displayed.

When the image diagnosis is completed, a screen illustrated in FIG. 6I is displayed, which will be described later.

As illustrated in FIG. 6I, a diagnosis result checking screen 680 for checking the diagnosis results in the past includes messages, icons, or buttons which are indicated by 681 to 685. The inspection date and time display region 681 displays a trigger or a factor prompting the execution of image diagnosis, and the execution date and time A diagnosis chart image display region 682 displays the diagnosis chart printed at the time of diagnosis. A diagnosis result switching button 683 is used to switch the diagnosis result to be displayed. A diagnosis message display region 684 displays a detailed message of the diagnosis result, and the operator can perform maintenance based on the display content. When a diagnosis result checking OK button 685 is pressed by the user, the inspection menu screen 600 may be displayed again.

Note that individual images illustrated in FIG. 6A to FIG. 6I are merely examples of the UI images used to realize the inspection function and the diagnosis function described herein, and the display mode may be changed without departing from the scope of the invention.

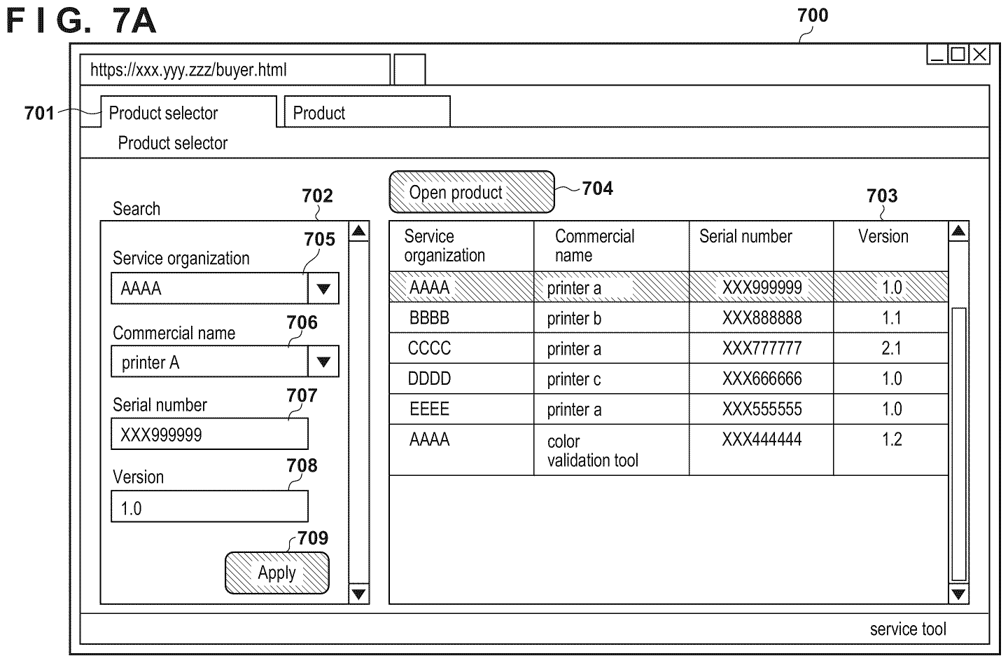

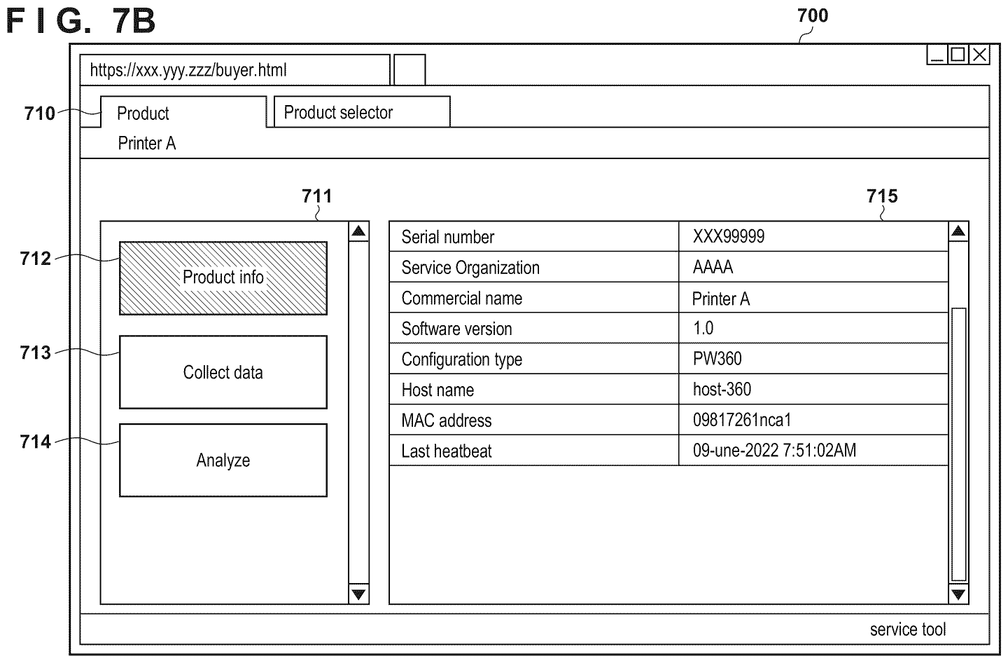

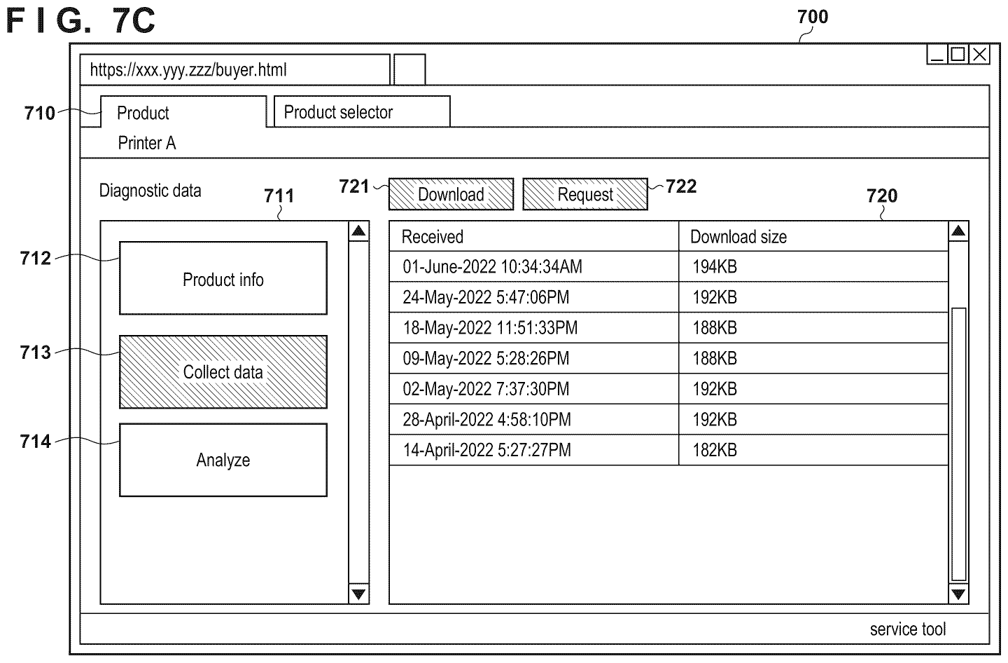

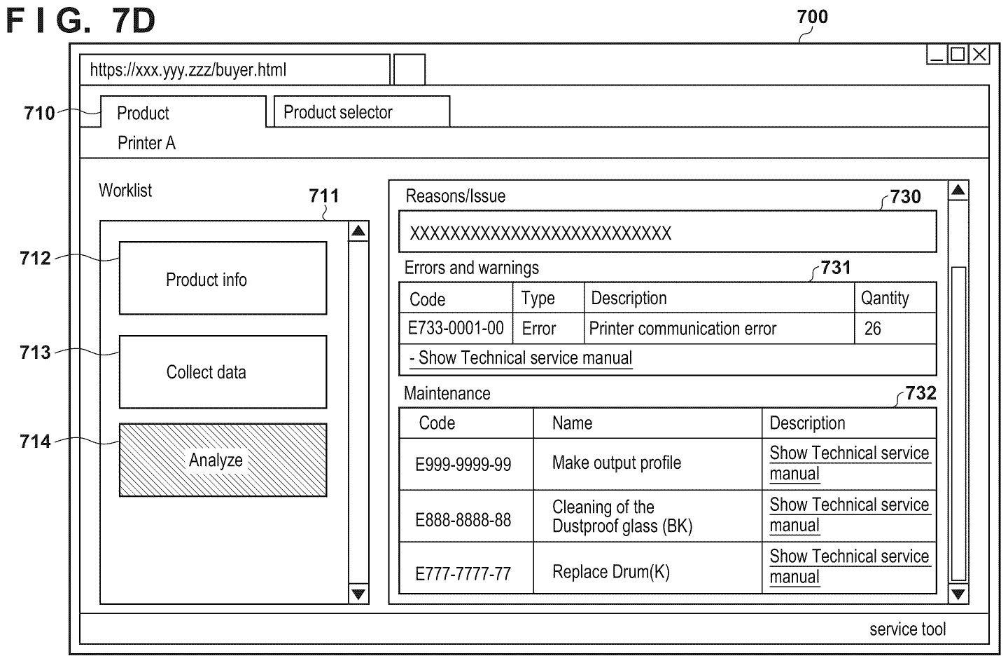

FIG. 7A to FIG. 7D are diagrams illustrating examples of a screen of the service tool 403.

FIG. 7A is a screen 700 for searching for a product to be maintained registered in the service tool 403, and an example of a search screen 700 as a web browser is illustrated.

The operator can search for a product for which a maintenance request is received, by referring to the screen 700. The service tool 403 is realized in the web system 101, and the operator can perform viewing and operation input via the screen 700. Note that this service may be used in other modes such as an on-premise application.

A product selection screen 701 in the screen 700 includes a product search section 702, a search result display section 703, and a product information view button 704. The product search section 702 includes a service organization selection section 705, a commercial name selection section 706, a serial number input section 707, a product version input section 708, and a search execution button 709. A list of products corresponding to the content selected or designated in the product search section 702 is displayed in the search result display section 703. When the product information view button 704 is pressed with respect to the product selected in the search result display section 703, a product information screen 710 illustrated in FIG. 7B is displayed.

FIG. 7B illustrates a display example of product information on the product information screen 710. The product information screen 710 includes a display menu selection section 711, and the display menu selection section 711 includes a product information display menu 712, a data collection menu 713, and a data analysis menu 714. In the product information display menu 712, for example, product information 715 indicating information such as a serial number, a service organization, a commercial name, a software version, a MAC address, and a last communication date and time of the selected product is displayed.

When the data collection menu 713 is pressed, a data collection screen illustrated in FIG. 7C is displayed on the product information screen 710. When the data analysis menu 714 is pressed, a data analysis screen illustrated in FIG. 7D is displayed on the product information screen 710.

As illustrated in FIG. 7C, on the data collection screen, a diagnosis data list 720 displays diagnosis data collected by the DFE 103. By pressing a download button 721, the user can download the diagnosis data selected in the diagnosis data list 720 to a local environment Further, by pressing a request button 722, the user can transmit a request that requests the DFE 103 to upload the diagnosis data, and in response to this, the DFE 103 creates the diagnosis data and transmits it to the service tool 403.

As illustrated in FIG. 7D, the worklist display unit 406 displays, in the data analysis screen, the recommended work specified by the worklist specifying unit 405 (see FIG. 4). A visit reason input section 730 is a text box to be input by the operator, and displays the content of maintenance, the cause thereof, and the like.

A maintenance factor display section 731 displays, as the maintenance factor, the cause of the maintenance being required for the image forming apparatus 104. Examples of the maintenance factor include a code, a type, detailed description, and the number of occurrences. Further, the maintenance factor display section 731 can also display information registered in the SMD database 404, for example, a URL of a technical service manual and the like. Since the maintenance factor is displayed in association with the technical service manual, the operator can relatively easily refer to the technical service manual for performing the maintenance.

A maintenance content display section 732 displays the content of maintenance or the content of work, such as replacement or cleaning of a component. For example, when a diagnosis result is displayed in the diagnosis message display region 684 (see FIG. 6I), the code converted at S515 (see FIG. 5) and the corresponding content of maintenance (content registered in the SMD database 404) may be displayed.

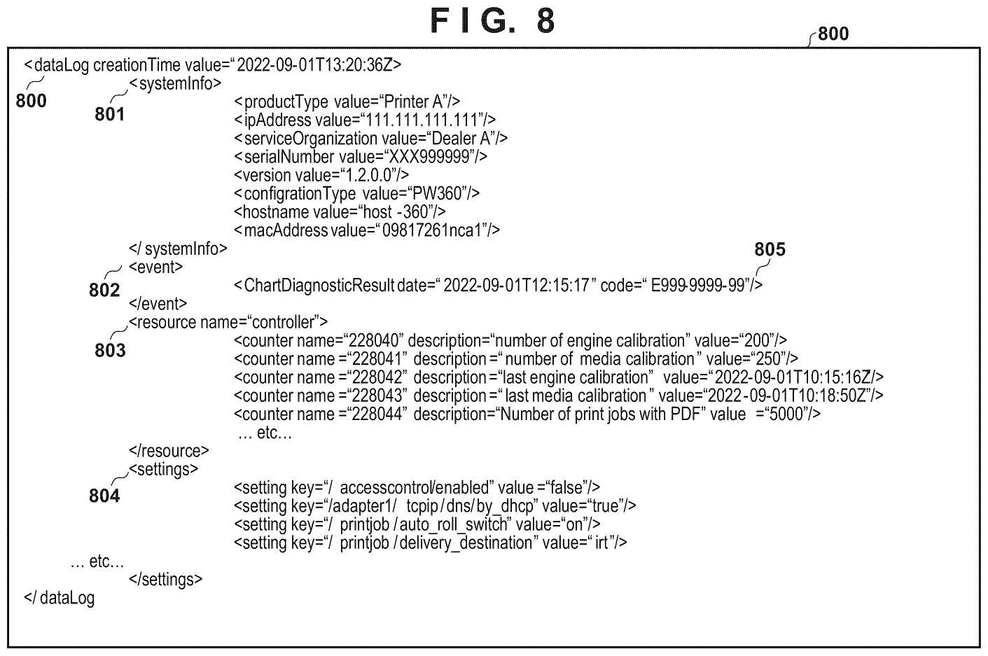

FIG. 8 is a diagram illustrating an example of diagnosis data 800 held in the DFE 103. The diagnosis data 800 is generally described in a format that can be processed by a program, and in the present embodiment, the diagnosis data 800 is described in an extensible markup language (XML) format. Accordingly, the service tool 403 can analyze the diagnosis data 800, and can display a screen corresponding to the analysis result.

System information 801 indicates configuration information of the DFE 103 such as an IP address and a serial number. The system information 801 is displayed in the product information display menu 712 of the product information screen 710 (see FIG. 7B).

Event information 802 indicates, as an event, the maintenance factor that has occurred in the DFE 103 or the image forming apparatus 104. For example, when a diagnosis result is displayed in the diagnosis message display region 684 (see FIG. 6I), the code corresponding to the diagnosis result and the time of the diagnosis are described in the event information 802, as an event 805 indicating the maintenance factor.

Equipment resource information 803 indicates statistical information managed by the DFE 103 or the image forming apparatus 104. Examples of the statistical information include the number of calibrations of the image forming apparatus 104, the number of calibrations for each sheet, the date and time of the last calibration each for the image forming apparatus 104 and the sheet which is performed latest, and the number of print jobs with Portable Document Format (PDF). In addition, although details will be described later, counter values of components of the image forming apparatus 104 may also be displayed.

System setting values of the DFE 103 and the image forming apparatus 104 are described in configuration information 804.

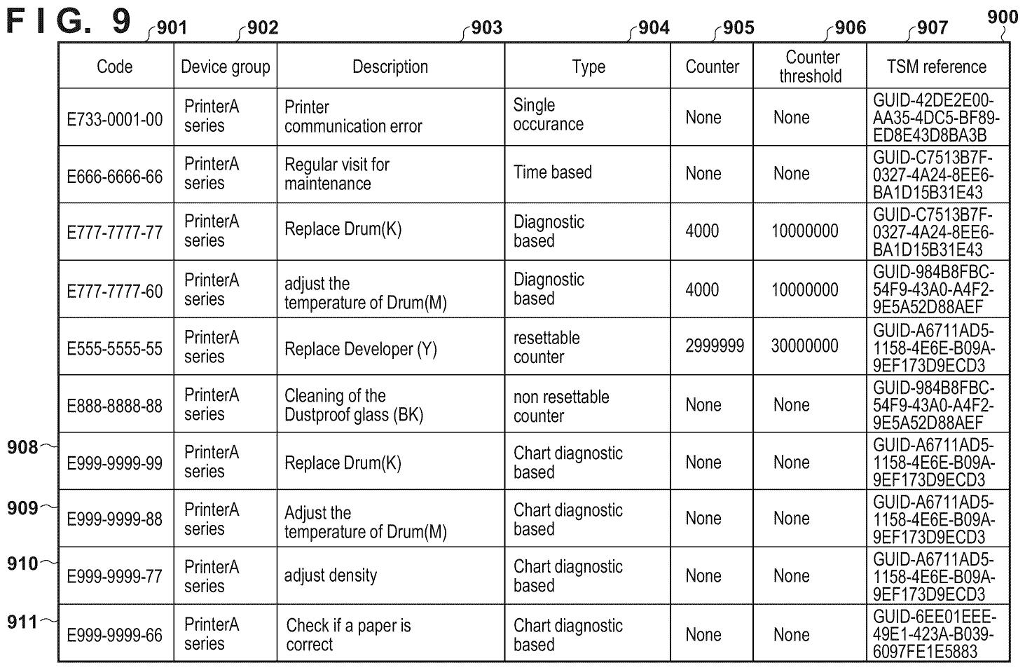

FIG. 9 illustrates a database 900 as an example of the SMD database 404. In this example, the database 900 includes seven columns 901 to 907.

The code column 901 stores a code, which makes it possible to specify the maintenance factor or the recommended work. The device group column 902 indicates a machine type, to which the service master data corresponds. The content column 903 indicates the content of the service master data.

The type column 904 indicates the type of the service master data. The number of types of the service master data is five in this example. The first type generally occurs only once, and relates to the maintenance factor described above. The second type occurs after a certain period of time elapses, and relates to minor maintenance such as a periodic inspection. The third type relates to a resettable counter in which, for example, a counter value of a component is reset when the component is replaced, and the counter value is counted up (or counted down) again from an initial value. The fourth type relates to a non-resettable counter in which, for example, a counter value of a component is not reset when the component is replaced, and the counter value is continuously accumulated. The fifth type can be specified by the image diagnosis based on the diagnosis function.

When the type of the service master data is the resettable counter, the current counter value (current value) is held in the counter column 905. The latest counter value (latest value) is acquired from the equipment resource information 803 of the diagnosis data 800, and the value of the counter column 905 is updated.

The counter threshold column 906 indicates a threshold value of the counter when the type of service master data is the resettable counter. If this threshold value is exceeded, the corresponding component is regarded as having reached the end of its product life and is to be replaced.

The technical service manual column 907 indicates the Globally Unique Identifier (GUID) of the technical service manual. The worklist display unit 405 displays the URL to the technical service manual based on the GUID (see FIG. 7D).

Each row of the database 900 represents the content of the service master data corresponding to each of the columns 901 to 907. The service tool 403 indicates information of the maintenance work based on the service master data. For example, service master data 908 indicates information for replacing a key plate drum. For example, service master data 909 indicates information for adjusting the temperature of a magenta drum. For example, service master data 910 indicates information for performing a density adjustment for the image forming apparatus 104. Further, for example, the service master data 911 indicates information for checking whether or not the sheet used in the image diagnosis based on the diagnosis function is appropriate.

According to such a configuration, when the printed material does not satisfy the standard based on the inspection function, it is possible to execute the image diagnosis based on the diagnosis function and to notify the result, and it is thus possible to reduce the load of the operator of the printing company system 102. Further, since the notification of the countermeasure is also promptly given to the operator, it is possible to reduce the time required until the maintenance is carried out, and it is thus possible to reduce the down time of the image forming apparatus 104. It can be said that all of these are advantageous in improving the usability of the image forming apparatus 104.

In the present embodiment, the inspection unit 304 corresponding to the inspection apparatus 105 and the inspection PC 106 has the inspection function and the diagnosis function. Here, the inspection unit 304 may be configured to be attachable to and detachable from the image forming apparatus 104, but may be integrated with the image forming apparatus 104. The inspection unit 304 corresponds to a support apparatus that supports the maintenance of the image forming apparatus 104.

### Second Embodiment

In the first embodiment, a mode is described in which, in response to the detection of the printed material not satisfying the predetermined standard based on the inspection function, the image diagnosis based on the diagnosis function is performed, the corresponding code is generated, and the maintenance factor and the recommended work for the maintenance are displayed. On the other hand, in the first embodiment, it is assumed that the inspection function is executed, and thus, preparation work for setting the inspection conditions and the like is required (see FIG. 6A and the like). Further, due to the time required for the inspection (for example, the time required for image capturing, image processing, and the like by the inspection apparatus 105), the printing speed may generally decrease.

In this regard, for example, there is a case where it is necessary to produce a plurality of copies of a printed material within a relatively short time, and it can be thus said that there is room for improvement.

A second embodiment is different from the first embodiment in that detection of the printed material not satisfying the predetermined standard is not used as a trigger.

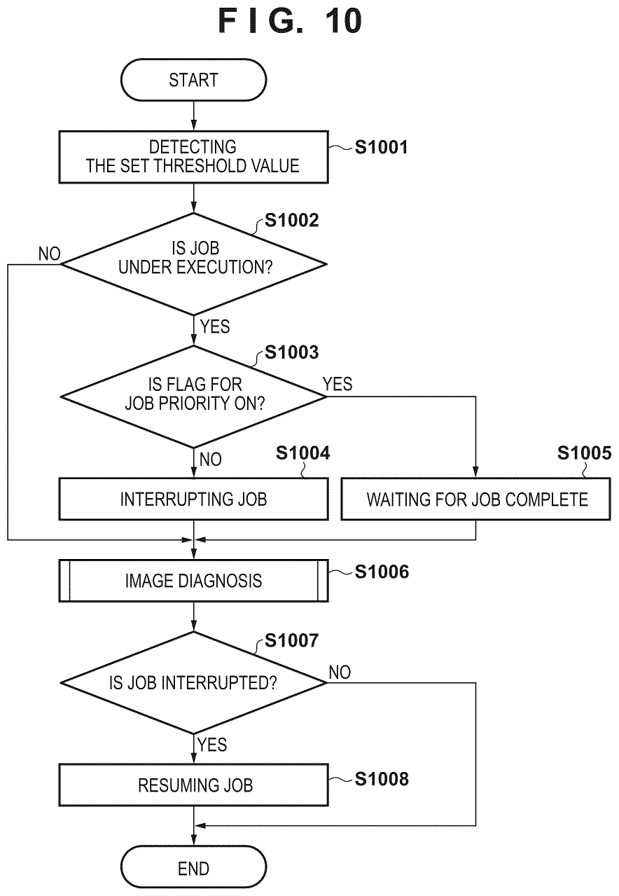

FIG. 10 is a flowchart illustrating the content of processing performed when the inspection PC 106 executes the automatic image diagnosis based on a threshold value set by the user. This flowchart may be executed by the inspection PC 106.

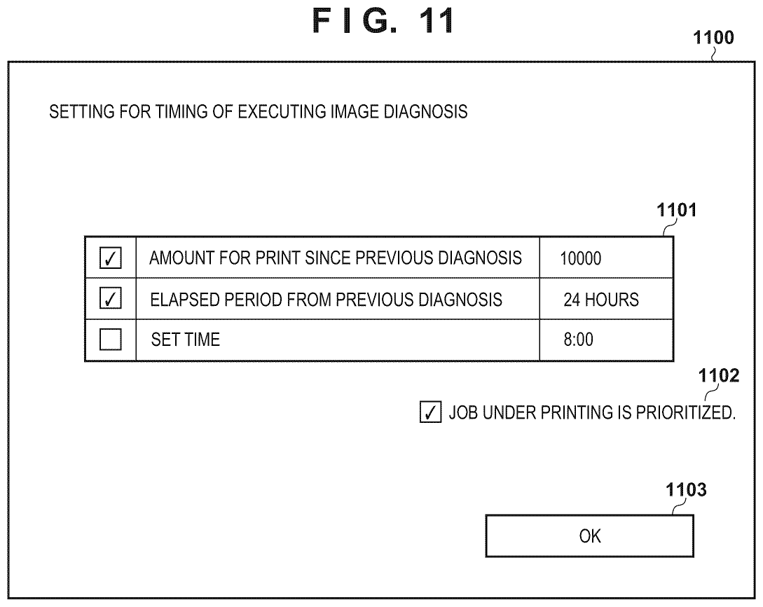

At S1001, it is detected whether or not a threshold value set in a UI screen (see FIG. 11) of the inspection PC 106 is reached. Examples of the threshold value include the number of printed materials from the previous image diagnosis, the elapsed period of time from the previous image diagnosis, the time, and the like. When the threshold value is reached, the processing proceeds to S1002, otherwise, the processing proceeds to S1006.

At S1002, it is determined whether or not the image forming apparatus 104 is being executed of a print job. When the print job is being executed, the processing proceeds to S1003, otherwise, the processing proceeds to S1006.

At S1003, it is determined whether or not it is set, in the UI screen of the inspection PC 106, that execution of the job being printed is prioritized over execution of the image diagnosis. When it is not set that the priority is given to the execution of the job being printed, the processing proceeds to S1004, and when it is set that the priority is given to the execution of the job being printed, the processing proceeds to S1005.

At S1004, the job being executed by the image forming apparatus 104 is interrupted, and subsequently, the processing proceeds to S1006.

At S1005, the processing stands by until the job being executed by the image forming apparatus 104 is completed, and proceeds to S1006 when the job is completed.

At S1006, the image diagnosis is executed, and when the printed material not satisfying the standard is detected, the result of the image diagnosis is transmitted to the web system 101. Note that this step is the same as S513 to S516 (see FIG. 5).

At S1007, it is determined whether or not the print job is interrupted at S1004. When the print job is interrupted, the processing proceeds to S1008, otherwise, the flowchart ends.

At S1008, the print job interrupted at S1004 is resumed. After the resumed print job is completed, the flowchart ends.

FIG. 11 is an example of an image diagnosis execution timing setting screen 1100 for setting a threshold value for automatically executing the image diagnosis in the inspection PC 106. The screen 1100 may be displayed by, for example, pressing another button that may be additionally provided on the inspection menu screen 600 (see FIG. 6A).

The setting screen 1100 includes an execution timing setting region 1101, a print-job-in-progress priority setting region 1102, and a setting completion button 1103.

The user can set the timing at which the inspection PC 106 executes the image diagnosis using the setting region 1101. In this example, the user can set the number of printed materials from the previous image diagnosis, and the elapsed period of time from the previous image diagnosis, and the time. The user can select which item is to be activated by inputting a check to the check box. For example, the determination at S1001 is made based on at least one (or all) of the items to which the check is input, and the image diagnosis is executed based on the determination result.

Further, the user can use the print-job-in-progress priority setting region 1102 to set whether to execute the image diagnosis after the job being printed by the image forming apparatus 104 is completed, or to interrupt the job and execute the image diagnosis, when the predetermined threshold value is reached at S1001. In this example, since the check is input to the check box and it is set that the job being printed is prioritized, the image diagnosis is executed after the completion of the job being printed.

Further, the user can complete the setting of the threshold value by pressing the setting completion button 1103, and subsequently, the inspection menu screen 600 may be displayed again.

According to the present embodiment, unnecessary execution of the inspection function is suppressed, and the printing speed can be maintained. And thus, for example, a plurality of copies of a printed material can be produced within a relatively short time. Therefore, according to the present embodiment, the same effect as that of the above-described first embodiment can be obtained. In addition, it can be said that the present embodiment is also advantageous in improving the productivity of the printed material.

### Third Embodiment

In the first embodiment, the setting in which the check is input to the check box of the image diagnosis execution setting region 644 (see FIG. 6E) (the setting in which the image diagnosis is automatically executed due to the occurrence of the continuous inspection NG) is described as an example On the other hand, although quality of a printed material generated by the image forming apparatus 104 does not satisfy the standard, quality of a printed material may satisfy the standard by, for example, an image quality adjustment (calibration), cleaning of a component, or the like. If the image diagnosis is executed even in such a case, an unnecessary increase in cost, such as an unnecessary replacement of a component, may be caused.

A third embodiment is different from the first embodiment in that an image quality adjustment is executed before executing the image diagnosis.

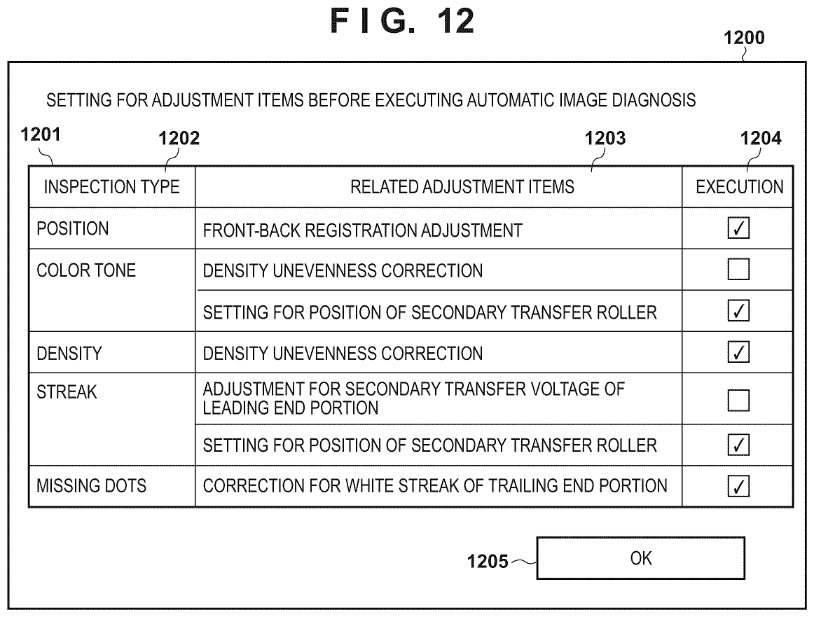

FIG. 12 is an example of a setting screen 1200 for adjustment items set before executing the image diagnosis.

The setting screen 1200 may be displayed by, for example, pressing another button that may be additionally provided on the condition setting screen 640 (see FIG. 6E). The adjustment item selection screen 1200 includes an adjustment item selection region 1201 and a selection completion button 1205.

The adjustment item selection region 1201 includes an inspection type display column 1202, a related adjustment item display column 1203, and an execution selection display column 1204. Execution/non-execution of each of the items in the display columns 1202 and 1203 can be selected in the display column 1204.

The inspection type display column 1202 indicates inspection types similar to those in the inspection type setting region 642 (see FIG. 6E). The related adjustment item display column 1203 indicates the adjustment item related to the inspection type. A check box is displayed in the execution selection display column 1204, and the inspection PC 106 instructs the image forming apparatus 104 to execute the inspection with respect to the adjustment item to which a check is input.

When the selection completion button 1205 is pressed, the condition setting screen 640 may be displayed again as the selection of the adjustment item is completed.

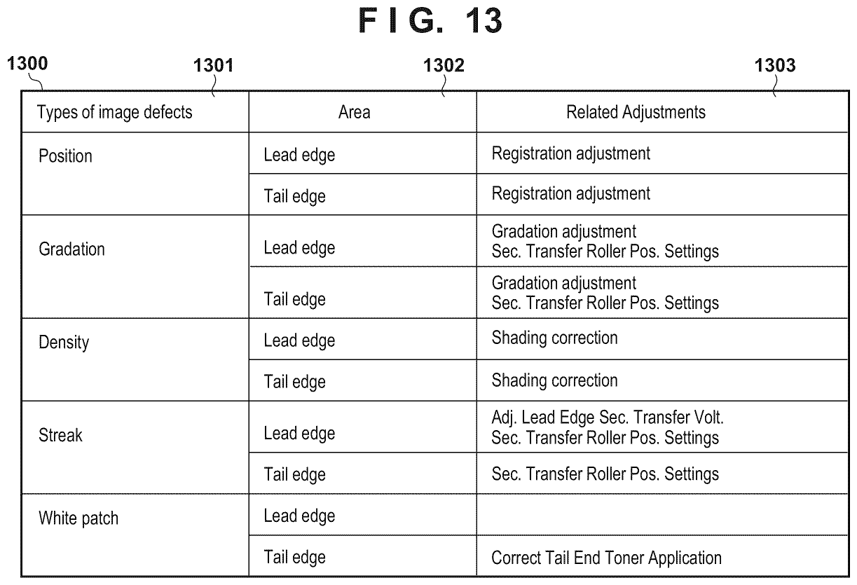

FIG. 13 is an example of a database 1300 in which the adjustment items corresponding to the inspection types displayed in the adjustment item selection region 1201 are listed. In the database 1300, all of the adjustment items related to the inspection types are listed, and the database 1300 includes an inspection type data column 1301, a detection area data column 1302, and a related adjustment item data column 1303. For example, the adjustment item can be specified (see the related adjustment item data column 1303) based on the area of the sheet where each item of the inspection type data column 1301 occurs (see the detection area data column 1302). Note that the inspection types, the areas, and the related adjustment items described in the data columns 1301 to 1303 are merely examples, and are not limited thereto.

According to the present embodiment, the execution of the image diagnosis can be avoided even for a case where the image quality can be restored by the image quality adjustment, and thus, an unnecessary increase in cost can be suppressed.

### OTHER EMBODIMENTS

Individual components in the foregoing embodiments are named using expressions based on their main functions, the functions mentioned in the embodiments may be sub-functions and the nomenclature is not strictly limited to such expressions. In addition, the expressions are replaceable by similar expressions. To the same effect, expressions such as “unit” or “portion” can be replaced by “tool”, “component”, “member”, “structure”, “assembly” or the like. Alternatively, those expressions may be omitted or attached.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-077386, filed May 9, 2023, which is hereby incorporated by reference herein in its entirety.

What is claimed is:

1. A support apparatus that supports maintenance of a printing apparatus, the support apparatus comprising:
at least one processor and at least a memory coupled to the at least one processor and having instructions stored thereon that, when executed by the at least one processor, causes the processor to act as:
a printing execution unit configured to cause the printing apparatus to execute printing of a test pattern;
a specifying unit configured to specify, based on the test pattern being printed, content of maintenance required for the printing apparatus; and
a notification unit configured to notify based on the content being specified.

2. The support apparatus according to claim 1, the at least one processor further acting as:
an image capturing unit configured to capture an image of a printed material output by the printing apparatus;
a registration unit configured to register an image to be formed on the printed material as a correct image; and
a comparison unit configured to compare the image of the printed material captured by the image capturing unit with the correct image,
wherein the printing execution unit executes the printing of the test pattern based on a comparison result by the comparison unit.

3. The support apparatus according to claim 2, the at least one processor further acting as:
an adjustment unit configured to adjust a printing mode of the printing apparatus based on the comparison result by the comparison unit.

4. The support apparatus according to claim 2, the at least one processor further acting as:
a cleaning unit configured to clean a component of the printing apparatus based on the comparison result by the comparison unit.

5. The support apparatus according to claim 2, the at least one processor further acting as:
a conversion unit configured to convert the content being specified into a code,
wherein the notification unit outputs, as a notification, the code being converted to a predetermined external apparatus.

6. The support apparatus according to claim 5, wherein
the conversion unit generates the code based on the comparison result by the comparison unit.

7. The support apparatus according to claim 1, the at least one processor further acting as:
a counting unit configured to count a number of operations performed by the printing apparatus,
wherein the printing execution unit causes the printing of the test pattern to be executed based on a counter value by the counting unit.

8. The support apparatus according to claim 7, the at least one processor further acting as:
a setting unit configured to set priority of the printing of the test pattern in execution of the printing by the printing apparatus,
wherein, in a case where the counter value reaches a threshold value during the execution of the printing by the printing apparatus, the printing execution unit determines, based on the set priority, whether to execute the printing of the test pattern.

9. A method for a support apparatus that supports maintenance of a printing apparatus, the method comprising:
causing the printing apparatus to execute printing of a test pattern;
specifying, based on the test pattern being printed, content of maintenance required for the printing apparatus; and
notifying based on the content being specified.

10. A non-transitory computer-readable storage medium that stores one or more programs including instructions, which when executed by one or more processors of a support apparatus that supports maintenance of a printing apparatus, cause the support apparatus to perform a control method, the control method comprising:
causing the printing apparatus to execute printing of a test pattern;
specifying, based on the test pattern being printed, content of maintenance required for the printing apparatus; and
notifying based on the content being specified.
